(19) United States
(12) Patent Application Publication
(10) Pub. No.: US 2026/0113756 A1
(43) Pub. Date: Apr. 23, 2026

(54) METHOD FOR DYNAMICALLY SPLITTING WIRELESS RESOURCES BETWEEN JOINTLY ALLOCATED COMMON RESOURCES FOR ONE OR MORE UL TRANSMISSIONS AND/OR DL TRANSMISSIONS

(71) Applicant: Telefonaktiebolaget LM Ericsson ( publ), Stockholm (SE)

(72) Inventor: Bikramjit SINGH, RAASEPORI (FI)

(73) Assignee: Telefonaktiebolaget LM Ericsson ( publ), Stockholm (SE)

(21) Appl. No.: 19/116,324

(22) PCT Filed: Oct. 12, 2022
(86) PCT No.: PCT/SE2022/050920

§ 371 Date: Mar. 27, 2025

(51) Int. Cl. H04W 72/232; H04W 72/21

(52) U.S. Cl. CPC H04W 72/232; H04W 72/21

(57) ABSTRACT

Embodiments herein relate to, for example, a method performed by a network node (12) for handling communication of a user equipment, UE, (10) in a communication network. The network node (12) transmits an indication to the UE (10), wherein the indication indicates a dynamically splitting of resources between jointly allocated common resources for one or more uplink, UL, transmissions and/or one or more downlink, DL, transmissions.

### TECHNICAL FIELD

Embodiments herein relate to a network node, a user equipment (UE) and methods performed therein regarding communication. Furthermore, a computer program product and a computer-readable storage medium are also provided herein. In particular, embodiments herein relate to handling communication, such as handling access and/or resources to access a communication network.

### BACKGROUND

In a typical communication network, UEs, also known as wireless communication devices, mobile stations, stations (STA) and/or wireless devices, servers, computers, communicate via an Access Network (AN), such as a radio access network (RAN) or a wired access network, with one or more core networks (CNs). The AN covers a geographical area which is divided into service areas or cells, with each service area or cell being served by a network node such as an access node e.g. a Wi-Fi access point or a radio network node such as a radio base station (RBS), which in some networks may also be called, for example, a NodeB, a gNodeB, or an eNodeB. The service area or cell is a geographical area where radio coverage is provided by the network node. The network node operates on radio frequencies to communicate over an air interface with the UEs within range of the access node. The network node communicates over a downlink (DL) to the UE and the UE communicates over an uplink (UL) to the access node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and investigate, e.g., enhanced data rate and radio capacity. In some RANs, e.g., as in UMTS, several radio network nodes may be connected, e.g., by landlines or microwave, to a controller node, such as a radio network controller (RNC) or a base station controller (BSC), which supervises, and coordinates various activities of the plural radio network nodes connected thereto. The RNCs are typically connected to one or more core networks.

Specifications for the Evolved Packet System (EPS) have been completed within the 3GPP and present and coming 3GPP releases, such as New Radio (NR) and extensions, are worked on. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the emerging 5G technologies such as new radio (NR), the use of very many transmit- and receive-antenna elements may be of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

### Time Division Duplex (TDD) UL/DL Common Configuration.

TDD is one of the important features deployed in 5G network due to the limited balanced spectrum availability. In LTE TDD, 7 predefined patterns are defined for UL and DL allocation in a radio frame. In 5G/NR, there aren't any predefined pattern. Instead, the pattern is defined in much more flexible manner, see FIG. 1.

### Downlink Control Information (DCI) Based TDD Pattern.

If TDD UL/DL common configuration is not used, UE determines if each of the slot is uplink or downlink and the symbol allocation within each of the slot purely by DCIs as stated in 38.213-11.1 Slot configuration.

If a UE is not configured to monitor physical downlink control channel (PDCCH) for DCI format 2_0, i.e., slot format indication (SFI), for a set of symbols of a slot that are indicated as flexible by higher layer parameters TDD-UL-DL-ConfigurationCommon or TDD-UL-DL-ConfigDedicated, when provided to a UE, or when TDD-UL-DL-ConfigurationCommon and TDD-UL-DL-ConfigDedicated are not provided to the UE:
the UE receives physical downlink shared channel (PDSCH) or channel state information reference signal (CSI-RS) in the set of symbols of the slot if the UE receives a corresponding indication by a DCI format 1_0, DCI format 1_1, or DCI format 0_1;
the UE transmits physical uplink shared channel (PUSCH), physical uplink control channel (PUCCH), physical random access channel (PRACH), or sounding reference signal (SRS) in the set of symbols of the slot if the UE receives a corresponding indication by a DCI format 0_0, DCI format 0_1, DCI format 1_0, DCI format 1_1, or DCI format 2_3.
DL, UL and flexible symbols as referred to in Section 11.1.1 in TS 38.213 specification.

TABLE 11.1.1-1
Slot formats for normal cyclic prefix

| | Symbol number in a slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 4 | D | D | D | D | D | D | D | D | D | D | D | D | F | F |
| 5 | D | D | D | D | D | D | D | D | D | D | D | F | F | F |
| 6 | D | D | D | D | D | D | D | D | D | D | F | F | F | F |
| 7 | D | D | D | D | D | D | D | D | D | F | F | F | F | F |
| 8 | F | F | F | F | F | F | F | F | F | F | F | F | F | U |
| 9 | F | F | F | F | F | F | F | F | F | F | F | F | U | U |
| 10 | F | U | U | U | U | U | U | U | U | U | U | U | U | U |
| 11 | F | F | U | U | U | U | U | U | U | U | U | U | U | U |
| 12 | F | F | F | U | U | U | U | U | U | U | U | U | U | U |
| 13 | F | F | F | F | U | U | U | U | U | U | U | U | U | U |
| 14 | F | F | F | F | F | U | U | U | U | U | U | U | U | U |
| 15 | F | F | F | F | F | F | U | U | U | U | U | U | U | U |
| 16 | D | F | F | F | F | F | F | F | F | F | F | F | F | F |
| 17 | D | D | F | F | F | F | F | F | F | F | F | F | F | F |
| 18 | D | D | D | F | F | F | F | F | F | F | F | F | F | F |
| 19 | D | F | F | F | F | F | F | F | F | F | F | F | F | U |
| 20 | D | D | F | F | F | F | F | F | F | F | F | F | F | U |
| 21 | D | D | D | F | F | F | F | F | F | F | F | F | F | U |
| 22 | D | F | F | F | F | F | F | F | F | F | F | F | U | U |
| 23 | D | D | F | F | F | F | F | F | F | F | F | F | U | U |
| 24 | D | D | D | F | F | F | F | F | F | F | F | F | U | U |
| 25 | D | F | F | F | F | F | F | F | F | F | F | U | U | U |
| 26 | D | D | F | F | F | F | F | F | F | F | F | U | U | U |
| 27 | D | D | D | F | F | F | F | F | F | F | F | U | U | U |
| 28 | D | D | D | D | D | D | D | D | D | D | D | D | F | U |
| 29 | D | D | D | D | D | D | D | D | D | D | D | F | F | U |
| 30 | D | D | D | D | D | D | D | D | D | D | F | F | F | U |
| 31 | D | D | D | D | D | D | D | D | D | D | D | F | U | U |
| 32 | D | D | D | D | D | D | D | D | D | D | F | F | U | U |
| 33 | D | D | D | D | D | D | D | D | D | F | F | F | U | U |
| 34 | D | F | U | U | U | U | U | U | U | U | U | U | U | U |
| 35 | D | D | F | U | U | U | U | U | U | U | U | U | U | U |
| 36 | D | D | D | F | U | U | U | U | U | U | U | U | U | U |
| 37 | D | F | F | U | U | U | U | U | U | U | U | U | U | U |
| 38 | D | D | F | F | U | U | U | U | U | U | U | U | U | U |
| 39 | D | D | D | F | F | U | U | U | U | U | U | U | U | U |
| 40 | D | F | F | F | U | U | U | U | U | U | U | U | U | U |
| 41 | D | D | F | F | F | U | U | U | U | U | U | U | U | U |
| 42 | D | D | D | F | F | F | U | U | U | U | U | U | U | U |
| 43 | D | D | D | D | D | D | D | D | D | F | F | F | F | U |
| 44 | D | D | D | D | D | D | F | F | F | F | F | F | U | U |
| 45 | D | D | D | D | D | D | F | F | U | U | U | U | U | U |
| 46 | D | D | D | D | D | F | U | D | D | D | D | D | F | U |
| 47 | D | D | F | U | U | U | U | D | D | F | U | U | U | U |
| 48 | D | F | U | U | U | U | U | D | F | U | U | U | U | U |
| 49 | D | D | D | D | F | F | U | D | D | D | D | F | F | U |
| 50 | D | D | F | F | U | U | U | D | D | F | F | U | U | U |
| 51 | D | F | F | U | U | U | U | D | F | F | U | U | U | U |
| 52 | D | F | F | F | F | F | U | D | F | F | F | F | F | U |
| 53 | D | D | F | F | F | F | U | D | D | F | F | F | F | U |
| 54 | F | F | F | F | F | F | F | D | D | D | D | D | D | D |
| 55 | D | D | F | F | F | U | U | U | D | D | D | D | D | D |

| | |
|---|---|
| 56-254 | Reserved |
| 255 | UE determines the slot format for the slot based on tdd-UL-DL- |
| | ConfigurationCommon, or tdd-UL-DL-ConfigurationDedicated and, if |
| | any, on detected DCI formats |

Extended reality (XR) Traffic

TABLE 1
See TS 22.261, v.18.6.1 Table 7.6.1-1 key performance indicators
(KPI) Table for high data rate and low latency service
Requirements and traffic assumptions for XR SI in 3GPP

```
Downlink video stream:
  Air interface one way:
    Augmented reality (AR)/ Virtual reality (VR): 10 ms (baseline)
    Cloud gaming (CG): 15 ms (baseline)
  Packet Arrival model:
    Average periodicity = 1/{60, [120]}
      => periodicity 16,67ms [or 8,33ms]
    Truncated Gaussian distribution:
      Mean: 0 ms; Standard deviation: 2ms; Truncation:
      [−4: 4ms]
  Average data rate for DL video stream:
    VR/AR: 30, 45 Mbps @60fps (baseline)
      30, 60 Mbps @60fps (optional)
    CG: 8, 30 Mbps @60fps (baseline)
      8, 45 Mbps @60fps (optional)
Uplink: For further study (FFS)
Conclusion
□ In 5G, XR is still being discussed
□ XR will be limited to 5G framework and therefore, it is not an attractive framework for this particular use case or other use cases exhibiting similarity to XR
□ 6G can offer better features as framework is not yet decided
□ XR traffic summary
∘ Periodical DL and UL
∘ UL is still under discussion but at least UL is realized for pose/control
∘ XR is treated DL heavy
□ UL traffic in practice can be heavy if there is UL streaming e.g., pictures/video/live feed uploading
∘ XR traffic per period is variable especially in DL under current assumptions
□ 3GPP definition is disclosed in SA4 TR 26.928, v.0.3.0 2019 Feb
□ Extended reality (XR) refers to all real-and-virtual combined environments and human-machine interactions. A key aspect of XR is especially relating to the senses of existence, represented by virtual reality (VR), and the acquisition of cognition, represented by augmented reality (AR).
□ The boundary of VR and AR is now blurred in reality
Fig. 2 shows present traffic details.
```

### Summary

As part of developing embodiments herein one or more problems were first identified. Embodiments herein may focus on dynamic TDD allocation to cater dynamic traffic, especially for new use cases being discussed in 5G, such as ultra-reliable low latency communication (URLLC), XR, Enhanced Mobile Broadband (eMBB) and also for use cases in 6G. 6G networks are expected to handle more variable and dynamic traffic than 5G networks due to wider range of use cases including low latency traffic like URLLC and XR traffic. Second, the cell density may be extremely high in 6G networks, which are expected to dominate solely beyond high band spectrum or THz frequencies, where cell sizes are small and more complicated interference scenarios, where patterns can be uncoordinated, may arise. Thus, problems may become severe in 6G, and it is required that TDD patterns must adapt to traffic pattern in 6G networks especially dealing with low latency traffic in each cell. Also, it seems inefficient to change TDD pattern of cells using explicit signalling like downlink control information (DCI) between network nodes and/or UEs, such as in 5G solutions, rather the focus should be on implicit determination or adaptation of TDD pattern as per traffic, whereas explicit signalling:
causes delay;
it requires constant knowledge of traffic pattern which may require additional signalling in order to convey traffic pattern, e.g., by UE to gNB, and
the knowledge of traffic pattern may not be available all the time at the network node if the traffic is random or sporadic or unpredictable.

For higher frequencies, such as mm wave, 100 GHz, a non-coordinated spectrum allocation may be desired. This is because transmissions are directive, and due to narrow beams, the transmissions don't interfere. Some internal studies have been conducted for 100 GHz under the study name: Coexistence performance (co-channel) of multiple URLLC factories at NR mid-band, where two networks are able to serve eMBB traffic with proper beamforming techniques in the same spectrum band. If different networks or cells have different UL-DL traffic needs, is there any need to conform with a same TDD pattern, or would one rather adapt to dynamic needs of the cells without causing inter-cell interference?

Higher frequencies will have an extremely small slot size, and now studies have come up with a RAN design which is an alternative to the current 5G NR RAN frame design. A UE may be allocated resources over 100s or 1000s of symbols, removing the slot-based dependency, whereas in 5G, the allocation granularity is based on slots where each slot consists of 14 symbols. Currently, proposals are limited to static UL and DL allocations over 1000s of symbols using a joint DCI. This is only useful if the bidirectional traffic, i.e., UL and DL traffic, is static, where the allocation ratio between DL and UL is fixed, e.g., 3:1 or 1:1, etc. If traffic is dynamic, e.g., changes after the allocation from joint DCI, then this fixed UL and DL allocation using a joint DCI is very resource unfriendly.

| | Characteristic parameter (KPI) | | | | | |
|---|---|---|---|---|---|---|
| | Max | Service bit rate: | | Influence quantity | | |
| | Allowed | user- | | | | Service |
| | End-to-end | experienced data | | # of | UE | Area |
| Use Cases | latency | rate | Reliability | UEs | Speed | (note 2) |
| Cloud/Edge/Split | 5 ms (i.e. | 0.1-[1] Gbit/s | 99.99% in | — | Stationary | Country |
| Rendering | UL + DL | supporting | uplink | | or | wide |
| (note 1) | between | visual content | and | | Pedestrian | |
| | UE and the | (e.g. VR based | 99.9% in | | | |
| | interface to | or high | downlink | | | |
| | data | definition video) | (note 4) | | | |
| | network) | with 4K, 8K | | | | |
| | (note 4) | resolution and | | | | |
| | | up to120 fps | | | | |
| | | content. | | | | |
| Gaming or | 10 ms (note | 0.1-[1] Gbit/s | 99.99% | ≤[10] | Stationary | 20 m × |
| Interactive | 4) | supporting | (note 4) | | or | 10 m; in |
| Data | | visual content | | | Pedestrian | one |
| Exchanging | | (e.g. VR based | | | | vehicle |
| (note 3) | | or high | | | | (up to |
| | | definition video) | | | | 120 |
| | | with 4K, 8K | | | | km/h) |
| | | resolution and | | | | and in |
| | | up to 120 fps | | | | one train |
| | | content. | | | | (up to |
| | | | | | | 500 |
| | | | | | | km/h) |
| Consume | [5-10] ms | 0.1-[10] Gbit/s | [99.99%] | — | Stationary | — |
| VR content | (note 5) | (note 5) | | | or | |
| via | | | | | Pedestrian | |
| tethered | | | | | | |
| VR | | | | | | |
| headset | | | | | | |
| (note 6) | | | | | | |

NOTE 1:
Unless otherwise specified, all communication via wireless link is between UEs and network node (UE to network node and/or network node to UE) rather than direct wireless links (UE to UE).
NOTE 2:
Length × width (×height).
NOTE 3:
Communication includes direct wireless links (UE to UE).
NOTE 4:
Latency and reliability KPIs can vary based on specific use case/architecture, e.g. for cloud/edge/split rendering, and may be represented by a range of values.
NOTE 5:
The decoding capability in the VR headset and the encoding/decoding complexity/time of the stream will set the required bit rate and latency over the direct wireless link between the tethered VR headset and its connected UE, bit rate from 100 Mbit/s to [10] Gbit/s and latency from 5 ms to 10 ms.
NOTE 6:
The performance requirement is valid for the direct wireless link between the tethered VR headset and its connected UE.

send new joint DCIs, or deactivate and reactivate new allocation, etc.

Services like XR have traffic variance, i.e., the traffic volume in DL and UL per cycle is not fixed. It would be desirable not to cater such traffic with a fixed TDD pattern, but rather with an adaptive TDD pattern towards such traffic since such traffic have a restricted latency.

Many networks may use a fixed TDD pattern in the licensed spectrum. To serve varying traffic, operators may utilize unlicensed spectrum for overshooting traffic in UL/DL. Thus, operators would need tools to change TDD patterns dynamically in unlicensed or licensed spectrum, e.g., in 5 or 6 GHz band.

In 5G, there is a standardized slot format indication (SFI) wherein flexible symbols that may be used for UL or DL are present. However, this is not a dynamic solution since it requires that the flexible symbols to be a-priori configured as DL or UL.

In addition, 3GPP has initiated artificial intelligence (AI)/machine learning (ML) studies/standardization for 5G networks and these modules are expected to mature and to be implemented in future 6G networks. This may enable 6G networks to adapt TDD patterns, where AI/ML procedures can help to estimate traffic related information and to bypass 5G based solutions for setting up TDD patterns.

In summary, there exists no robust solution for a dynamic TDD allocation to serve bidirectional traffic, especially for use cases, such as:
XR
Small cells or femtocells network in unlicensed spectrum, e.g., NR-U
mmWave band
THz band
Frequency range 2 (FR2)
52.6 to 71 GHz.
Higher frequencies
Hotspots or femto cells in low band frequencies.

An object herein is to provide a mechanism to handle communication efficiently in a communication network.

According to an aspect the object is achieved, according to embodiments herein, by providing a method performed by a network node for handling communication of a UE in a communication network. The network node transmits an indication to the UE, wherein the indication indicates a dynamically splitting of resources between jointly allocated common resources for one or more UL transmissions and/or DL transmissions.

According to another aspect the object is achieved, according to embodiments herein, by providing a method performed by a UE for handling communication of the UE in a communication network. The UE receives an indication from a network node, wherein the indication indicates a dynamically splitting of resources between jointly allocated common resources for one or more UL transmissions and/or one or more DL transmissions. The UE further uses resources for receiving one or more DL transmissions and/or transmitting one or more UL transmissions based on the indication.

According to yet another aspect the object is achieved, according to embodiments herein, by providing a network node for handling communication of a UE in a communication network. The network node is configured to transmit an indication to the UE, wherein the indication indicates a dynamically splitting of resources between jointly allocated common resources for one or more UL transmissions and/or DL transmissions.

According to yet another aspect the object is achieved, according to embodiments herein, by providing a UE for handling communication of the UE in a communication network. The UE is configured to receive an indication from a network node, wherein the indication indicates a dynamically splitting of resources between jointly allocated common resources for one or more UL transmissions and/or one or more DL transmissions. The UE is further configured to use resources for receiving one or more DL transmissions and/or transmitting one or more UL transmissions based on the indication.

It is furthermore provided herein a computer program product comprising instructions, which, when executed on at least one processor, cause the at least one processor to carry out the methods herein, as performed by the network node and the UE, respectively. It is additionally provided herein a computer-readable storage medium, having stored thereon a computer program product comprising instructions which, when executed on at least one processor, cause the at least one processor to carry out the methods herein, as performed by the network node and the UE, respectively.

Embodiments herein propose a dynamic resource allocation using the indication, e.g., using a DCI, that caters to variable volume in DL and UL traffic over a resource allocated by the DCI. The resources are allocated to both DL and UL traffic altogether, however the allocation may be non-fixed for DL and UL shared channel in this block of resources. The decision to use which part of the resources for UL and DL depends on
a rule;
the traffic in buffer;
dynamism in traffic; and/or
which initial node that transmits the traffic, wherein remaining resources are used for the traffic in the other direction.

Resources, such as slots in time and/or frequency, are dynamically allocated for both DL and UL altogether without fixed segregation between UL and DL resource. The resource selection in either direction may be based on relative traffic in node's buffer or assigned rule or policy, and may be indicated to the UE using the indication.

The proposed dynamically splitting of resources between jointly allocated common resources enables adaption to traffic variation and can support low latency traffic, variable traffic like XR and use cases with higher frequencies.

Thus, embodiments herein handle communication efficiently for UEs in the communication network.

### BRIEF DESCRIPTION OF THE DRAWINGS

Embodiments will now be described in more detail in relation to the enclosed drawings, in which:

FIG. 1 shows a block diagram depicting a TDD pattern according to prior art;

FIG. 2 shows present traffic models;

FIG. 3 shows a communication network according to embodiments herein;

FIG. 4 shows a combined signalling scheme and flowchart according to embodiments herein;

FIG. 5 shows a flowchart depicting a method performed by a network node according to embodiments herein;

FIG. 6 shows a flowchart depicting a method performed by a UE according to embodiments herein;

FIG. 7 shows a block diagram depicting a transmission according to some embodiments herein;

FIG. 8 shows a block diagram depicting a transmission according to some embodiments herein;

FIG. 9 shows a block diagram depicting a transmission according to some embodiments herein;

FIG. 10 shows a block diagram depicting a transmission according to some embodiments herein;

FIG. 11 shows a block diagram depicting a transmission according to some embodiments herein;

FIGS. 12a-12b show schematic overviews depicting a network node according to embodiments herein;

FIGS. 13a-13b show schematic overviews depicting a UE according to embodiments herein;

FIG. 14 schematically illustrates a telecommunication network connected via an intermediate network to a host computer;

FIG. 15 is a generalized block diagram of a host computer communicating via a base station with a user equipment over a partially wireless connection; and

FIGS. 16-19 are flowcharts illustrating methods implemented in a communication system including a host computer, a base station and a user equipment.

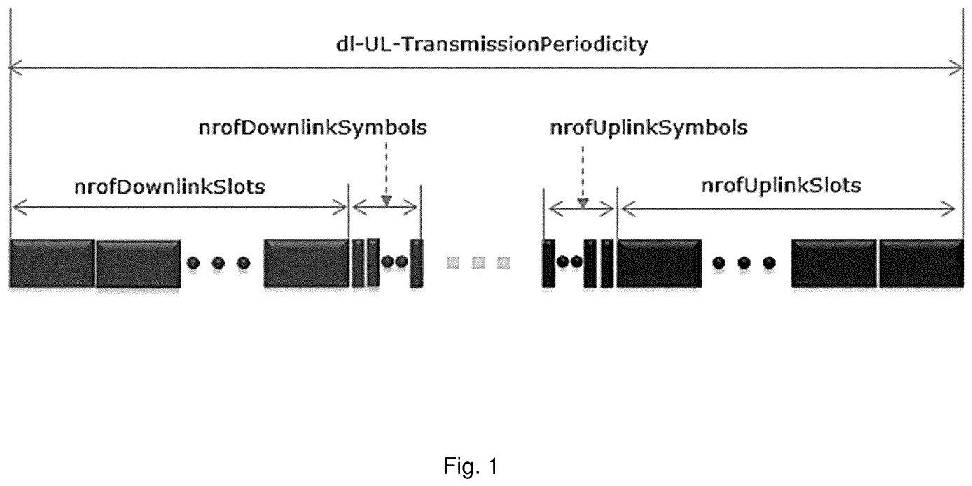

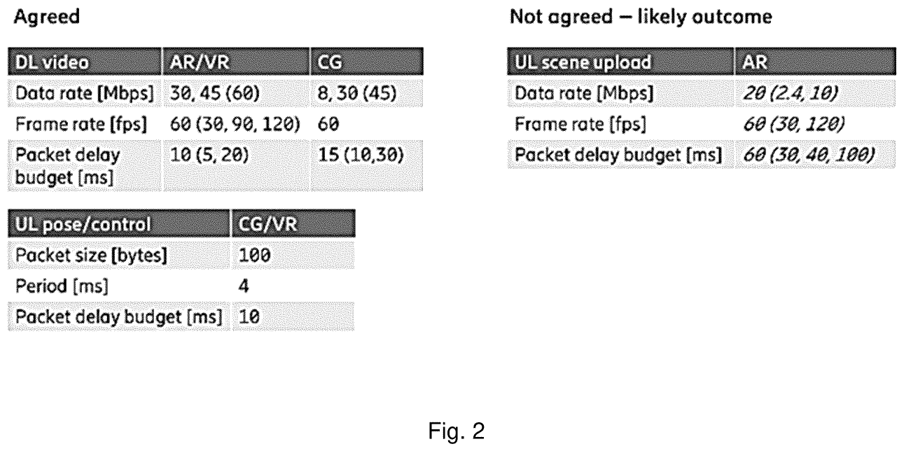

### DETAILED DESCRIPTION

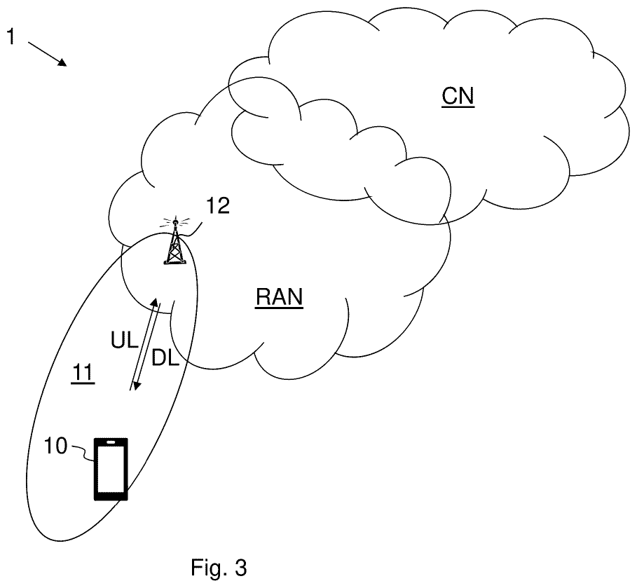

Embodiments herein relate to communication networks in general. FIG. 3 is a schematic overview depicting a communication network 1. The communication network 1 comprises one or more access networks, such as RANs or wired access networks, and one or more CNs. The communication network 1 may use one or a number of different technologies. Embodiments herein relate to recent wired and wireless networks such as Wi-Fi, new radio (NR), other existing wired or wireless networks, and further developments of existing wireless communications systems such as e.g., LTE or WCDMA but also upcoming releases such as 6G.

In the communication network 1, a UE 10, for example, a wireless device such as a mobile station, a non-access point (non-AP) station (STA), a STA and/or a wireless terminal, is comprised communicating via the one or more Access Networks (AN) to other UEs or one or more CNs. It should be understood by the skilled in the art that “UE” is a non-limiting term which means any terminal, wireless communications terminal, internet of things (IoT) device, Machine Type Communication (MTC) device, Device to Device (D2D) terminal, or node e.g. smart phone, laptop, mobile phone, sensor, relay, mobile tablets or even a small base station capable of communicating using radio communication with a network node within an area served by the network node.

The communication network 1 comprises a network node 12 providing radio coverage over a geographical area, a first service area 11 or first cell, of a first RAT, such as WiFi, NR, LTE, or similar. The network node 12 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a UE within the area served by the network node depending e.g. on the first radio access technology and terminology used. The network node 12 may be an access node such as a WiFi-modem or a radio network node and may be referred to as a serving network node wherein the service area may be referred to as a serving cell. It should be noted that a service area may be denoted as cell, beam, beam group or similar to define an area of radio coverage.

According to embodiments herein the network node 12 transmits an indication to the UE 10, wherein the indication indicates a dynamically splitting of resources between jointly allocated common resources for one or more UL transmissions and/or DL transmissions. The UE 10 then uses resources for receiving one or more DL transmissions and/or transmitting one or more UL transmissions based on the received indication. Dynamically splitting herein meaning that a number of resources are flexible whether to be used for UL transmissions or DL transmissions. Furthermore, jointly allocated common resources are resources that may be dynamically used for UL and/or DL transmissions for the UE 10. Thus, cells are not forced to coordinate TDD pattern and each cell can utilize their resources as per their UL and DL traffic demand.

The proposed dynamically splitting of resources between jointly allocated common resources enables adaption to traffic variation and can support low latency traffic, variable traffic like XR and use cases with higher frequencies.

XR traffic: Such traffic is variable and typically they need large grant. It is plausible, when a UE is allocated granted, when DCI is sent, the node (gNB/UE) is still receiving data in its buffer. Thus, it is beneficial, if a large unrestrained allocation is provided, even after sending a DCI, the changes in buffer status can adapt to the allocation, as UL and DL resources are not fixed in this resource allocation.

Bidirectional Traffic: More scenarios are being envisaged where it is expected bidirectional and dependent traffic. Currently, there are no standardized allocations to cater such needs, and embodiments herein help to cater adaptive bidirectional traffic, e.g., XR (UL and DL video in multi-UE gaming).

NR-Unlicensed channels: TDD patterns are not separately allocated for separate channels, but rather channels comprise flexible symbols or slots for providing dynamic allocations using joint DCI. The interference between the flows/streams can be curbed by having offsets in the form of physical resource blocks (PRB), this is similar where two channels are separated by a guard band where each channel can have different TDD pattern.

Higher frequencies band, such as 52.6 to 71 GHz, and beyond 100 GHz: It is assumed, at higher frequencies, that licensed spectrum is not needed since transmissions are highly narrow and directive and have considerable path loss. This means that the transmissions don't spread and don't interfere easily to others. Practically, it makes sense to have spectrum at higher frequencies in the form of unlicensed or uncoordinated sharing basis, wherever license can be provided similar to Citizens Broadband Radio Service (CBRS)-like methodologies in a small geographical area. Having said that, due to uncoordinated neighbouring cells operation, each cell can choose desired resource allocation with dynamic split among DL and UL. This is beneficial since cells are not forced to coordinate their TDD pattern and each cell can utilize their resources as per their UL and DL traffic demand.

Interference control: The interference mentioned above regarding NR-U channels and Higher frequencies band can be controlled by following methods:
Beamforming techniques
Apply guard period between period allocations contain different bidirectional traffic
Use listen before talk (LBT) or sensing techniques

High frequencies have higher path loss and narrow beams, in built characteristics, that limit the interference, so in general, interference is not a stringent issue for higher frequencies. This is provided in multiple simulation-based studies conducted internally to support eMBB and URLLC traffic in high bands.

Embodiments herein may be in licensed, unlicensed, CBRS, TDD, frequency division duplex (FDD) spectrum or any combination.

Below embodiments, the term joint DCI is used, this is basically terminology to indicate DCI allocates resources for both UL and/or DL. One can also say just DCI.

DL transmission can be understood as PDSCH but not always as DL transmission can be a DCI, system information block (SIB) signalling, etc.

UL transmission can be understood as PUSCH but not always as UL transmission can be an uplink control information (UCI).

In below embodiments, by resource allocation, it is meant the resource allocated by a DCI or joint DCI.

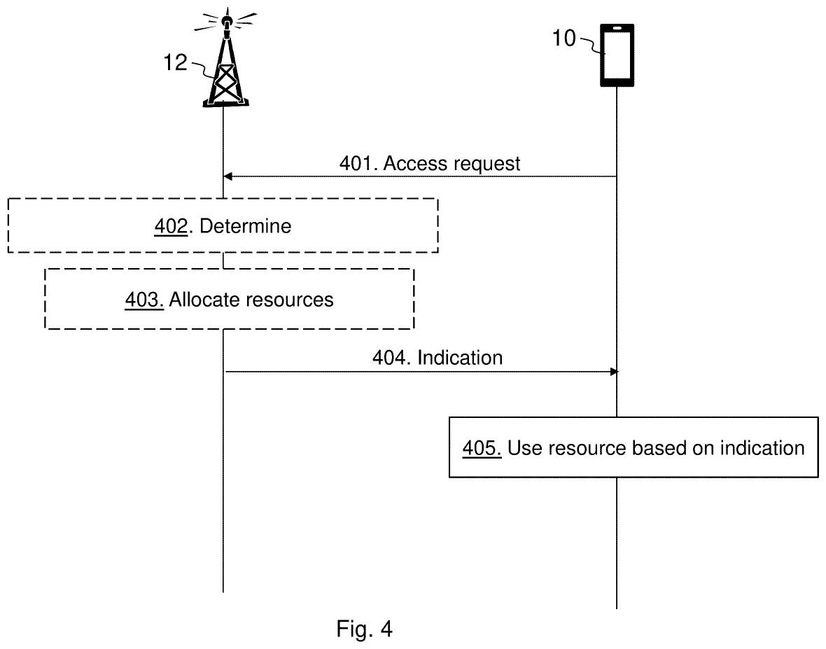

FIG. 4 is a combined signalling and flowchart scheme according to some embodiments herein focusing on the estimated signal quality.

Action 401. The UE 10 transmits a request for accessing the network node 12 or a cell related to the network node 12. The request may comprise an indication indicating or similar.

Action 402. The network node 12 may determine to allow the UE 10 to access the network node 12. For example, the network node 12 may, based on available resources/requested resources or similar, determine whether the UE 10 should be allowed or not to access the network node 12 or cell 11.

Action 403. The network node 12 may further allocate one or more resources to be dynamically used for both DL and/or UL transmissions for the UE 10.

Action 404. The network node 12, according to embodiments herein, transmits the indication to the UE 10, wherein the indication indicates the dynamically splitting of resources between jointly allocated common resources for one or more UL transmissions and/or DL transmissions. The indication may be a dynamic grant of allocated resources to be used dynamically for both UL and DL communication for the UE 10.

Action 405. The UE 10 the uses the resources for receiving one or more DL transmissions and/or transmitting one or more UL transmissions based on the indication. Thus, the resources are used dynamically taken the received indication into account.

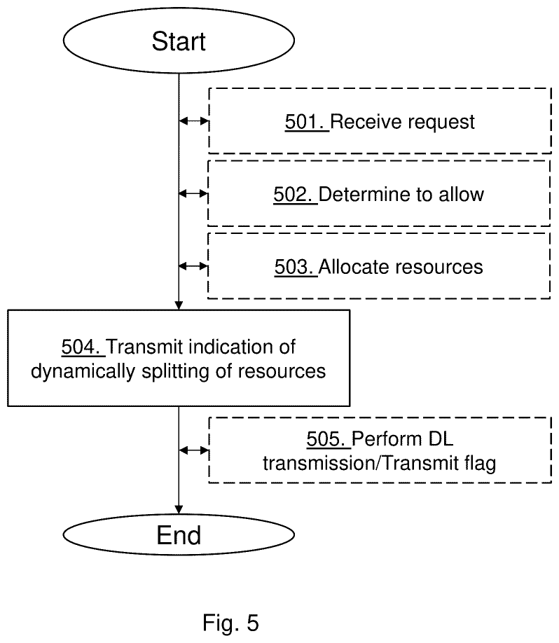

The method actions performed by the network node 12, such as a radio network node, for handling communication of the UE 10 in the communication network 1 according to embodiments will now be described with reference to a flowchart depicted in FIG. 5. The actions do not have to be taken in the order stated below but may be taken in any suitable order. Dashed boxes indicate optional features.

Action 501. The network node 12 may receive from the UE 10 the request for accessing the network node 12 or a cell related to the network node 12.

Action 502. The network node 12 may determine to allow the UE 10 to access the network node 12. For example, the network node 12 may, based on available resources/requested resources or similar, determine whether the UE 10 should be allowed or not to access the network node 12 or cell.

Action 503. The network node 12 may further allocate one or more resources to be dynamically used for both DL and UL transmissions for the UE 10.

Action 504. The network node 12 transmits the indication to the UE 10, wherein the indication indicates the dynamically splitting of resources between jointly allocated common resources for one or more UL transmissions and/or one or more DL transmissions. The indication may be a dynamic grant of allocated resources to be used dynamically for both UL and DL communication for the UE 10. The indication may comprise a dynamic grant of allocated resources to be used dynamically for multiple UL communications and/or DL communications for the UE with different transmission characteristics and requirements. Hence, a dynamic splitting of resources for multiple ULs or multiple DLs with different characteristics, such as reliability, priority, quality of service (QoS), may herein be provided.

The dynamically splitting of resources may be based on one or more rules. The one or more rules may be based on a traffic buffer level at the network node 12 or the UE 10. The one or more rules may define that one or more DL transmissions are done first, and then one or more UL transmissions may be performed for one or more remaining resources. Alternatively, the one or more rules may define that one or more UL transmissions are done first, and then one or more DL transmissions may be performed for one or more remaining resources.

The indication may comprise a joint DCI comprising parameters related to both DL decoding and UL encoding information.

Action 505. The network node 12 may perform a DL transmission to the UE 10 and may transmit a flag or control information indicating an end of the DL transmission. Alternatively, the network node 12 may transmit a flag or DCI defining the splitting of the resources transmitted along PDSCH. Thus, the receiving UE 10 may be informed of the end of the DL transmission and may then use the rest of the jointly allocated common resources for UL transmission or transmissions.

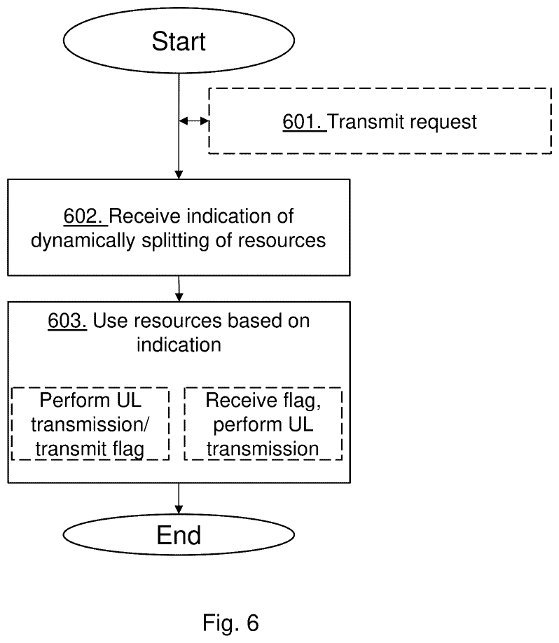

The method actions performed by the UE 10 for handling communication of the UE 10 in the communication network 1 according to embodiments will now be described with reference to a flowchart depicted in FIG. 6. The actions do not have to be taken in the order stated below but may be taken in any suitable order. Dashed boxes indicate optional features.

Action 601. The UE 10 may transmit an access request to the network node 12.

Action 602. The UE 10 receives the indication from the network node 12, wherein the indication indicates the dynamically splitting of resources between the jointly allocated common resources for the one or more UL transmissions and/or the one or more DL transmissions. The indication may comprise a dynamic grant of allocated resources, i.e., the jointly allocated common resources, to be used dynamically for both UL and DL communication for the UE 10. The indication may comprise a dynamic grant of allocated resources to be used dynamically for multiple UL communications and/or DL communications for the UE 10 with different transmission characteristics and requirements. The dynamically splitting of resources may be based on one or more rules. The one or more rules may be based on a traffic buffer level at the network node 12 or the UE 10. The indication may comprise a joint DCI, comprising parameters related to both DL decoding and UL encoding information.

Action 603. The UE 10 further uses resources for receiving one or more DL transmissions and/or transmitting one or more UL transmissions based on the indication. The one or more rules may define that one or more DL transmissions are done first, and the UE 10 may be using the resources by waiting of the DL transmission to end and then performing UL transmission on one or more remaining resources. The one or more rules may define that one or more UL transmissions are done first, and then the UE 10 may receive one or more DL transmissions on one or more remaining resources. The UE 10 may be using the resources by performing an UL transmission to the network node 12 and then transmitting a flag or control information indicating end of the UL transmission. The UE 10 may be using the resources by receiving a flag or DCI, transmitted along PDSCH, defining the splitting of the resources, and may then perform an UL transmission.

Dynamic allocations of resources by a “DCI” or “joint DCI” are not associated with DL and/or UL shared channels, rather association is defined for just shared channel, for example, for data transmission in either direction.

The utilization of resources for UL and/or DL may be decided based on rules which may not be specified in DCI or joint DCI.

In one embodiment, the rule or rules for resource selection may be
pre-configured, e.g., specified by radio resource control (RRC) signalling
based on traffic queue at the transmitting node (network node or UE).

The utilization of resources based on rules may be for following non-limited options
UL
   Dynamic single or multi-PUSCH (multi-slot UL)
DL
   Dynamic single or multi-PDSCH (multi-slot DL)
DL and UL (in any order)
   Combination of dynamic single or multi-PUSCH and PDSCH

The use of resources allocated by a joint DCI may be based on a rule where DL transmission is done first, and then UL transmission is performed on the remaining resources, such as slots or symbols, of the jointly allocated common resources.

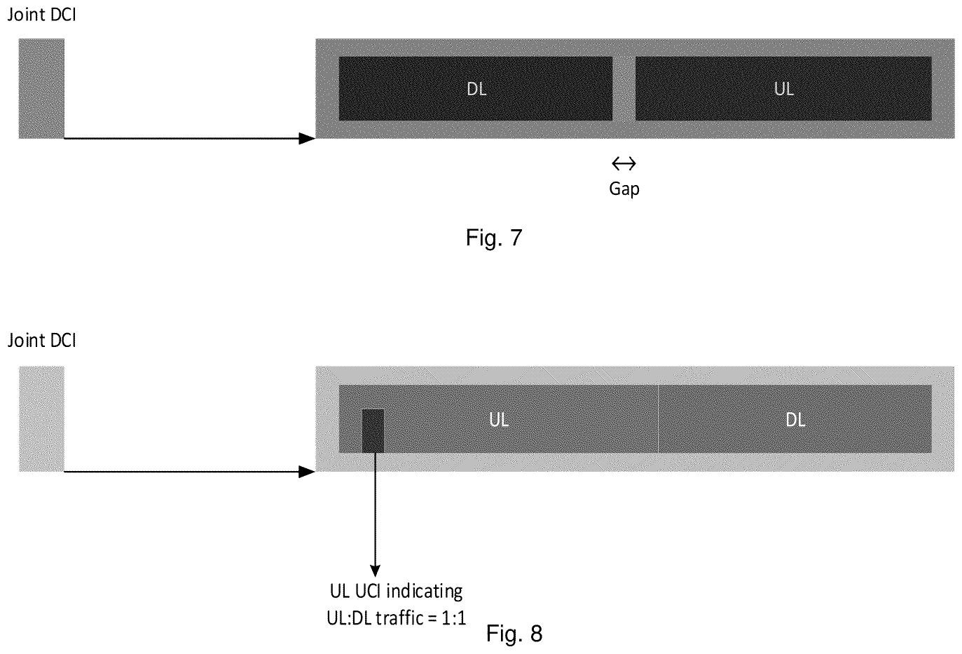

For example, after DL transmission, the UE 10 may wait for X symbols, and may then transmit UL on remaining symbols, see FIG. 7.

This solves the problem of needing to know the configuration beforehand, where on a number of resources with 400 symbols allocated by a joint DCI, where the network node 12 transmits DL data over around 200 symbols, then UE 10 may wait for 1-2 symbols after DL completion, and then the UE 10 may start perform UL transmissions in the remaining 198 symbols. Otherwise, if a fixed allocation for DL to UL with 3:1 ratio is used, then network node 12 may send DL over 200 symbols, then remaining 100 DL symbols are wasted, and in last 100 symbols the UE 10 transmits UL, and still UE has 100 symbols of worth UL data with no resource in its possession given that traffic ratio is 1:1 in the buffer.

It should be noted that the joint DCI may contain parameters related to both DL decoding and UL encoding information.

Thus, FIG. 7 shows a flexible split between DL and UL resources based on UE and network node traffic.

As explained above, the use of resources allocated by a joint DCI may be based on a rule where UL transmission is done first, and then DL transmission may be performed on the remaining resources (slots/symbols).

The network node 12 may define a resource split ratio, e.g., the network node 12 may define N number of configurations in UE's RRC signalling, and whenever UE wants to transmit on this shared channel, it uses a configuration, and start with UL transmission. For example, the UE 10 is allocated a resource of 400 symbols by a joint DCI, and the UE 10 is configured with 3 configurations related UL and DL split over the resource, namely 1:3, 3:1 and 1:1. The UE 10 may have a rather large amount of UL data, so the UE 10 uses 1:3 split and indicates to the network node 12, e.g., with some UCI or UL medium access control (MAC) control element (CE), that the UE 10 uses the 1:3 split, which means that the network node 12 uses 100 symbols for DL and remaining 300 symbols will used by the UE 10 for UL over the jointly allocated common resources.

FIG. 8 shows where the UE 10 sends UCI to indicate the desired split. In the example, the UE 10 indicates a 1:1 split between UL and DL.

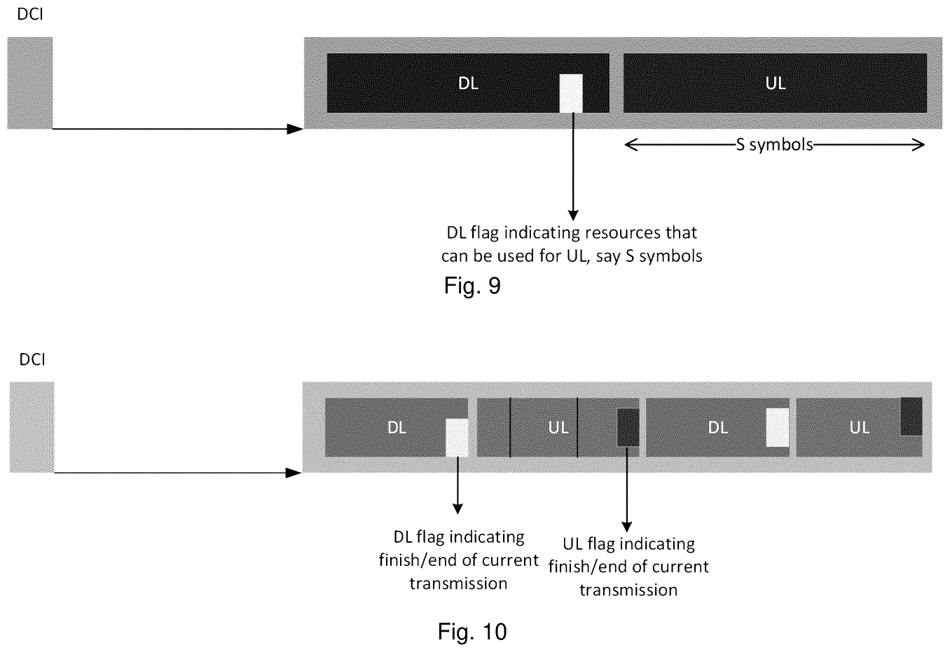

The network node 12 may define resource split ratio or an absolute amount of resources (for UL, DL) with a flag/or in a small DCI transmitted along PDSCH. See FIG. 9. FIG. 9 shows where the network node 12 sends a flag multiplexed with PDSCH to indicate the desired split. For example, the network node 12 may indicate with a DL flag resources that may be used for UL such as S symbols.

The UE 10 may wait for DL transmission in a first symbol or first R symbols or slots in the jointly allocated common resources.

If a DL transmission is received or initiated by the network node 12, then
a. The UE 10 may back-off from doing any UL transmission in the jointly allocated common resources.
b. The network node 12 may utilize part or whole resource for DL

Alternatively, or additionally, the network node 12 may wait for an UL transmission in the first symbol or first R symbols or slots in the jointly allocated common resources.

If an UL transmission is done or initiated by the UE 10, then
c. The network node 12 may back-off from doing any DL transmission in the jointly allocated common resources
d. The UE 10 may utilize part or whole jointly allocated common resources for UL

Note: The objective focuses on dynamic resource usage are for resources in unlicensed and/or licensed spectrum.

Whenever a node, such as the network node 12 or the UE 10, finishes its transmissions, the network node 12 or the UE 10 may include a flag, e.g., a UCI in UL or DCI in DL, to indicate the end of the transmission.

For example, after the end of a transmission, the receiving node may initiate its transmission, and again after completing the transmission, the receiving node may include end/finish flag to mark the completion of its transmission, see FIG. 10. FIG. 10 shows wherein each node indicates by including a flag or control information indicating end of current transmission or transmissions, so that other node can initiate the transmissions. Note, in 2^{nd} block (1^{st} UL block), it is exemplified a split or resources into 3 transmissions, which can be equivalent to 3 UL hybrid automatic repeat request (HARQ) processes, and the flag is included in a last HARQ process, i.e., 3^{rd} UL transmission, shown in the FIG. 10, to indicate the end of multi-UL transmissions.

Thus, the jointly allocated common resources, which are not fixed for DL or UL, rather the usage depends on the one or more rules, may be configured as flexible (non-associated) symbols or slots.

A DCI may indicate combination of fixed DL resource, fixed UL resource and flexible resources and/or jointly allocated common resources.

The jointly allocated common resources may be used for different transmission types in same direction on a dynamic basis without indicating in joint DCI/DCI about specific resources for these transmissions See FIG. 11 where after sending UL pose or other type of traffic, then remaining resources are used for UL video. FIG. 11 shows a DCI allocating R slots. UE sends R1 slots for UL pose traffic. Afterwards, the UE 10 may use remaining slots R2 for video traffic. Note, the network node 12 does not specify R1 and R2, and it is up to UE and the rules for selection of resources from set R (<R1+R2) for different traffic types.

When a node, such as the network node 12 or the UE 10, transmits its transmission, it may be based on multiple of resource units where the resource units may be Y symbols or Y slots. This will help receiving node to understand what the predicted usage is by transmitting node. For example, a resource of 100 slots is allocated (slot #0 to slot #99), and a node is allowed to use multiple of 10 slots, and if the UE 10 transmits first, then the network node 12 knows that UE 10 will end transmission at slot #9, #19, #29, and so on. This will help in reduced blind decoding at the receiving node if flags are not used by the transmitting node to indicate the end of transmissions.

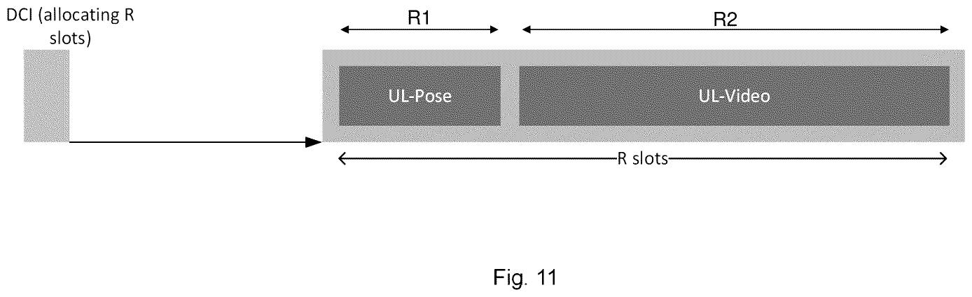

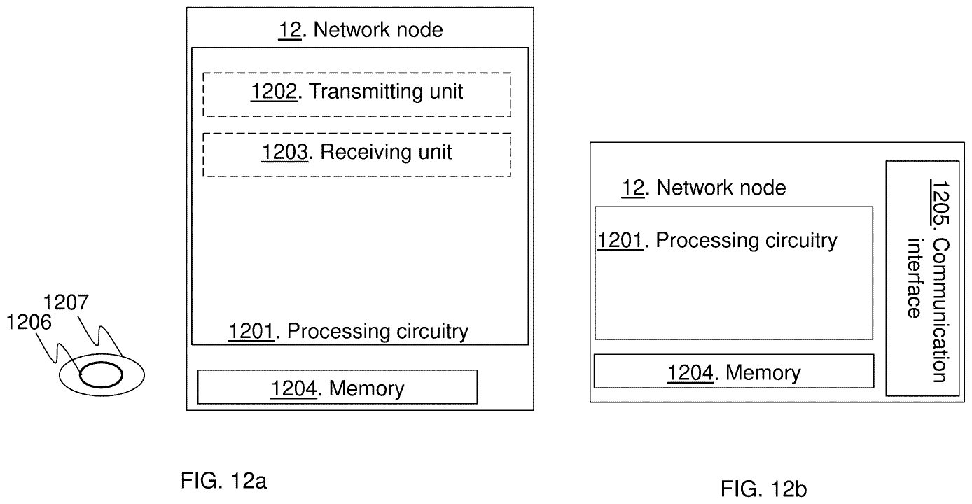

FIGS. 12a-b are schematic overviews of the network node 12 for handling communication of the UE 10 in the communication network according to embodiments herein.

The network node 12 may comprise processing circuitry 1201, e.g., one or more processors, configured to perform the methods herein.

The network node 12 may comprise a transmitting unit 1202, such as a transmitter and/or transceiver. The network node 12, the processing circuitry 1201 and/or the transmitting unit 1202 is configured to transmit the indication to the UE 10, wherein the indication indicates a dynamically splitting of resources between jointly allocated common resources for one or more UL transmissions and/or one or more DL transmissions. The indication may comprise the dynamic grant of allocated resources to be used dynamically for both UL and DL communication for the UE 10. The indication may comprise a dynamic grant of allocated resources to be used dynamically for multiple UL communications and/or DL communications for the UE 10 with different transmission characteristics and requirements. The dynamically splitting of resources may be based on one or more rules. The one or more rules may be based on a traffic buffer level at the network node 12 or the UE 10. The one or more rules may define that one or more DL transmissions are done first, and then one or more UL transmissions may be performed on one or more remaining resources. The one or more rules may define that one or more UL transmissions are done first, and then one or more DL transmissions may be performed on one or more remaining resources. The indication may comprise a joint DCI comprising parameters related to both DL decoding and UL encoding information. The network node 12, the processing circuitry 1201 and/or the transmitting unit 1202 may be configured to perform a DL transmission to the UE and to transmit a flag or control information indicating an end of the DL transmission. The network node 12, the processing circuitry 1201 and/or the transmitting unit 1202 may be configured to transmit a flag or DCI, defining the splitting of the resources transmitted along the PDSCH.

The network node 12 may comprise a receiving unit 1203, such as a receiver and/or transceiver. The network node 12, the processing circuitry 1201 and/or the receiving unit 1203 may be configured to receive one or more UL transmissions from the UL over the jointly allocated common resources.

The network node 12 may comprise a memory 1204. The memory 1206 comprises one or more units to be used to store data on, such as data packets, grants, parameter(s), jointly allocated common resources, resource information, configuration, indications, flags, thresholds, measurements, events and applications to perform the methods disclosed herein when being executed, and similar. Furthermore, the network node 12 may comprise a communication interface 1205, see FIG. 12b, comprising such as a transmitter, a receiver, a transceiver and/or one or more antennas.

The methods according to the embodiments described herein for the network node 12 are respectively implemented by means of e.g. a computer program product 1206 or a computer program, see FIG. 12a, comprising instructions, i.e., software code portions, which, when executed on at least one processor, cause the at least one processor to carry out the actions described herein, as performed by the network node 12. The computer program product 1206 may be stored on a computer-readable storage medium 1207, see FIG. 12a, e.g., a disc, a universal serial bus (USB) stick or similar. The computer-readable storage medium 1207, having stored thereon the computer program product, may comprise the instructions which, when executed on at least one processor, cause the at least one processor to carry out the actions described herein, as performed by the network node 12. In some embodiments, the computer-readable storage medium may be a transitory or a non-transitory computer-readable storage medium. Thus, embodiments herein may disclose a network node for handling communication of a UE in the communication network, wherein the network node 12 comprises processing circuitry and a memory, said memory comprising instructions executable by said processing circuitry whereby said network node is operative to perform any of the methods herein.

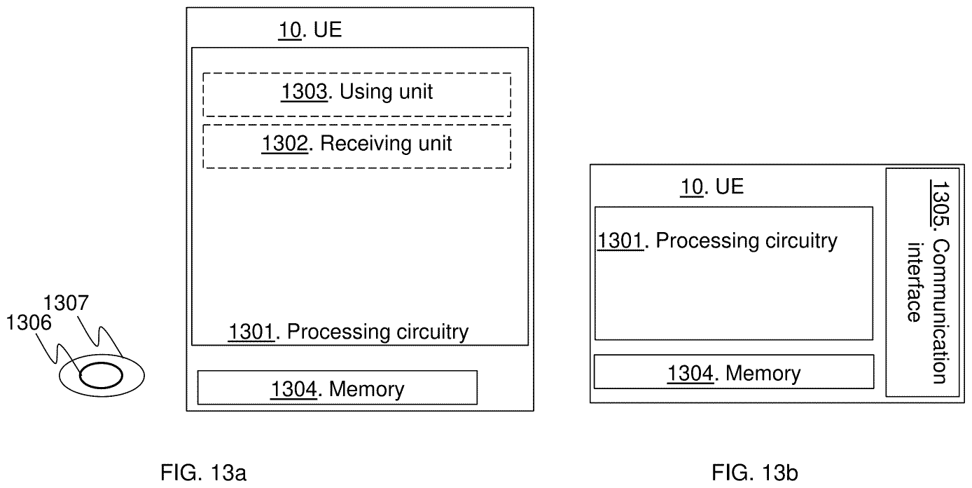

FIGS. 13a-b are schematic overviews of the UE 10 for handling communication of the UE in the communication network 1 according to embodiments herein.

The UE 10 may comprise processing circuitry 1301, e.g. one or more processors, configured to perform the methods herein.

The UE 10 may comprise a receiving unit 1302, e.g., the receiver, or transceiver. The UE 10, the processing circuitry 1301, and/or the receiving unit 1302 may be configured to receive from the network node 12, the indication, wherein the indication indicates the dynamically splitting of resources between jointly allocated common resources for one or more UL transmissions and/or one or more DL transmissions. The indication may comprise a dynamic grant of allocated resources to be used dynamically for both UL and DL communication for the UE 10. The indication may comprise a dynamic grant of allocated resources to be used dynamically for multiple UL communications and/or DL communications for the UE 10 with different transmission characteristics and requirements. The dynamically splitting of resources may be based on the one or more rules. The one or more rules may be based on a traffic buffer level at the network node or the UE. The one or more rules may be defining that one or more UL transmissions are done first and then one or more DL transmissions may be performed on one or more remaining resources. The indication may comprise a joint DCI, comprising parameters related to both DL decoding and UL encoding information.

The UE 10 may comprise a using unit 1303, e.g., a writer, a transmitter, a receiver or transceiver. The UE 10, the processing circuitry 1301, and/or the using unit 1303 is configured to use resources for receiving one or more DL transmissions and/or transmitting one or more UL transmissions based on the indication. The one or more rules may define that one or more DL transmissions are done first, and wherein the UE 10, the processing circuitry 1301, and/or the using unit 1303 may be configured to use the resources by waiting of the one or more DL transmissions to end and then to perform one or more UL transmissions on one or more remaining resources. The UE 10, the processing circuitry 1301, and/or the using unit 1303 may be configured to use the resources by performing one or more UL transmissions to the network node 12 and transmitting a flag or control information indicating end of the one or more UL transmissions. The UE 10, the processing circuitry 1301, and/or the using unit 1303 may be configured to use the resources by receiving a flag or DCI transmitted along PDSCH, defining the splitting of the resources, and then by performing an UL transmission.

The UE 10 may comprise a memory 1304. The memory 1304 comprises one or more units to be used to store data on, such as data packets, grants, parameter(s), indices, jointly allocated common resources, resources, configuration, indications, measurements, events and applications to perform the methods disclosed herein when being executed, and similar. Furthermore, the UE 10 may comprise a communication interface 1305, see FIG. 13b, such as comprising a transmitter, a receiver, a transceiver and/or one or more antennas.

The methods according to the embodiments described herein for the UE 10 are respectively implemented by means of e.g. a computer program product 1306 or a computer program, see FIG. 13a, comprising instructions, i.e., software code portions, which, when executed on at least one processor, cause the at least one processor to carry out the actions described herein, as performed by the UE 10. The computer program product 1306 may be stored on a computer-readable storage medium 1307, see FIG. 13a, e.g. a disc, a universal serial bus (USB) stick or similar. The computer-readable storage medium 1307, having stored thereon the computer program product, may comprise the instructions which, when executed on at least one processor, cause the at least one processor to carry out the actions described herein, as performed by the UE 10. In some embodiments, the computer-readable storage medium may be a transitory or a non-transitory computer-readable storage medium. Thus, embodiments herein may disclose a UE 10 for handling communication of the UE 10 in the communication network, wherein the UE 10 comprises processing circuitry and a memory, said memory comprising instructions executable by said processing circuitry whereby said UE 10 is operative to perform any of the methods herein.

In some embodiments a more general term “network node” is used and it can correspond to any type of radio-network node or any network node, which communicates with a wireless device, wired device and/or with another network node. Examples of network nodes are, router, modem, server, UE, NodeB, master (M) eNB, secondary(S) eNB, a network node belonging to Master cell group (MCG) or Secondary cell group (SCG), base station (BS), multi-standard radio (MSR) radio node such as MSR BS, eNodeB, gNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), internet of things (IoT) capable device, machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

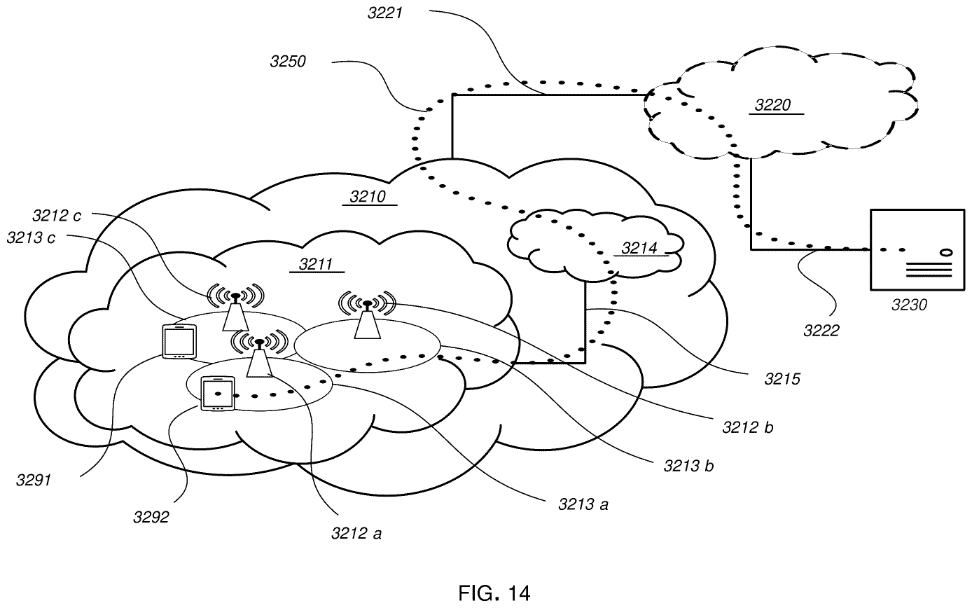

With reference to FIG. 14, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the network node 12 herein, each defining a corresponding coverage area 3213a, 3213b, 3213c. Each base station 3212a, 3212b, 3212c is connectable to the core network 3214 over a wired or wireless connection 3215. A first UE 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 14 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

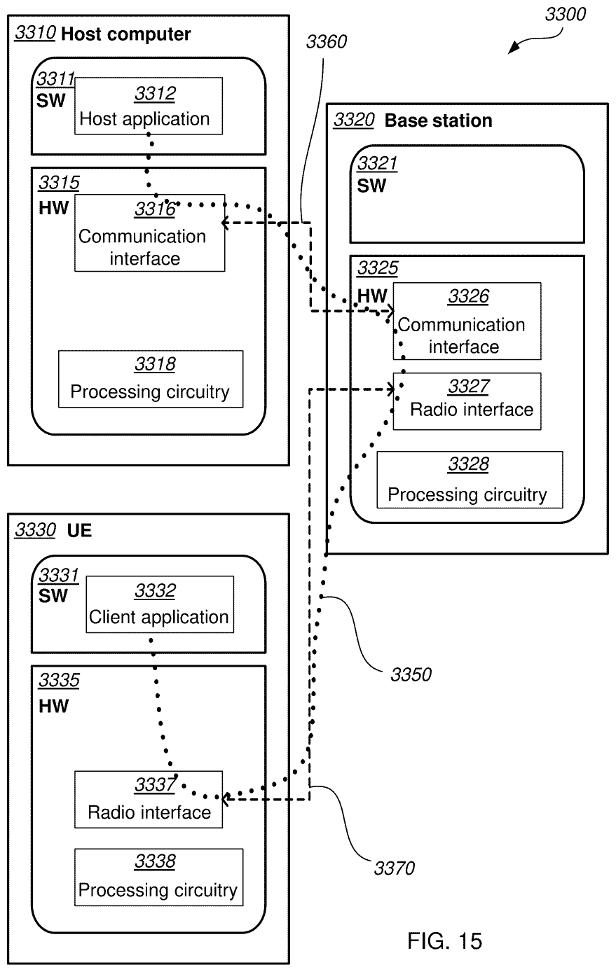

Example implementations, in accordance with an embodiment, of the UE, base station and host computer discussed in the preceding paragraphs will now be described with reference to FIG. 15. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 15) served by the base station 3320. The communication interface 3326 may be configured to facilitate a connection 3360 to the host computer 3310. The connection 3360 may be direct or it may pass through a core network (not shown in FIG. 15) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 15 may be identical to the host computer 3230, one of the base stations 3212a, 3212b, 3212c and one of the UEs 3291, 3292 of FIG. 14, respectively. This is to say, the inner workings of these entities may be as shown in FIG. 15 and independently, the surrounding network topology may be that of FIG. 14.

In FIG. 15, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing, e.g., on the basis of load balancing consideration or reconfiguration of the network.

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since the transmissions are more flexible and thereby provide benefits such as improved efficiency and may lead to better performance such as better responsiveness of the UE.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

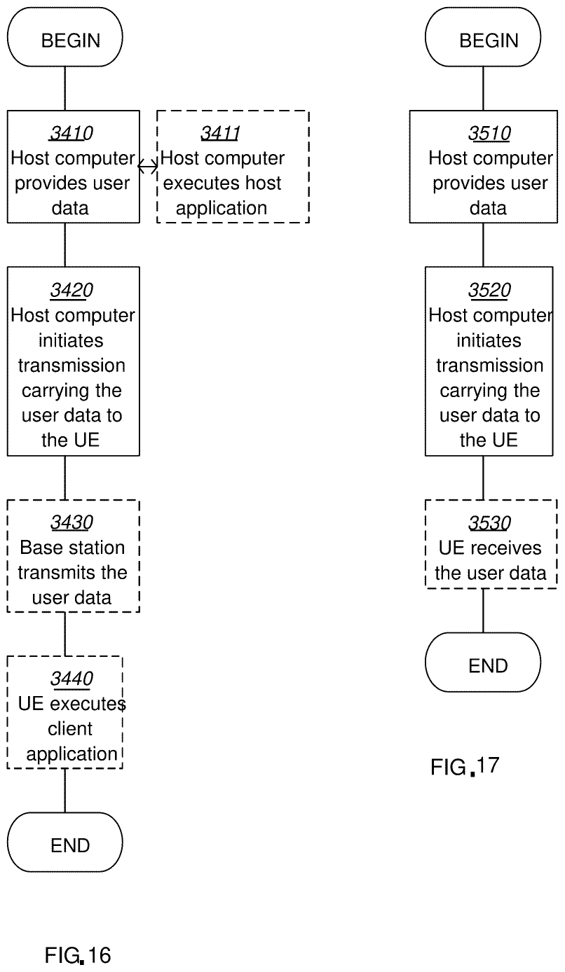

FIG. 16 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 16 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 17 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 17 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

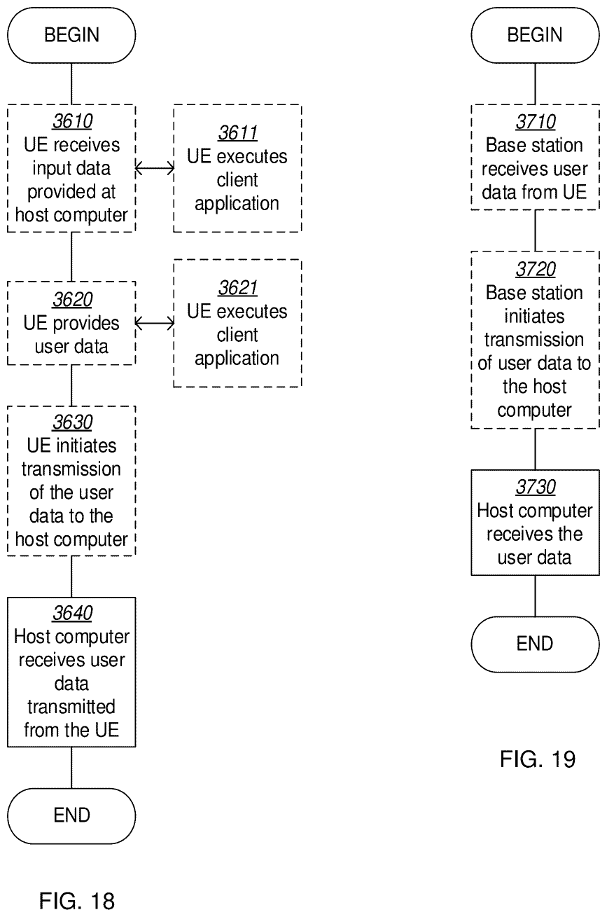

FIG. 18 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 18 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 19 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 19 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1. A method performed by a network node for handling communication of a user equipment, UE, in a communication network, the method comprising:
transmitting an indication to the UE, wherein the indication indicates a dynamically splitting of resources between jointly allocated common resources for one or more uplink, UL, transmissions or one or more downlink, DL, transmissions.

2. The method according to claim 1, wherein the indication comprises a dynamic grant of allocated resources to be used dynamically for both UL and DL communication for the UE.

3. The method according to claim 1, wherein the indication comprises a dynamic grant of allocated resources to be used dynamically for multiple UL communications or DL communications for the UE with different transmission characteristics and requirements.

4. The method according to claim 1, wherein the dynamically splitting of resources is based on one or more rules.

5. The method according to claim 4, wherein the one or more rules is based on a traffic buffer level at the network node or the UE.

6. The method according to claim 4, wherein the one or more rules is defining that one or more DL transmissions are done first, and then one or more UL transmissions are performed on one or more remaining resources.

7. The method according to claim 4, wherein the one or more rules is defining that one or more UL transmissions are done first, and then one or more DL transmissions are performed on one or more remaining resources.

8. The method according to claim 1, wherein the indication comprises a joint downlink control information, DCI, comprising parameters related to both DL decoding and UL encoding information.

9. The method according to claim 1, further comprising
performing a DL transmission to the UE and transmitting a flag or control information indicating an end of the DL transmission.

10. The method according to claim 1, further comprising
transmitting a flag or downlink control information, DCI, defining the splitting of the resources transmitted along physical downlink shared channel, PDSCH.

11-32. (canceled)

33. A user equipment, UE, for handling communication of the UE in a communication network, wherein the UE is configured to:
receive an indication from a network node, wherein the indication indicates a dynamically splitting of resources between jointly allocated common resources for one or more uplink, UL, transmissions or one or more downlink, DL, transmissions; and
use resources for receiving one or more DL transmissions or transmitting one or more UL transmissions based on the indication.

34. The UE according to claim 33, wherein the indication comprises a dynamic grant of allocated resources to be used dynamically for both UL and DL communication for the UE.

35. The UE according to claim 33, wherein the indication comprises a dynamic grant of allocated resources to be used dynamically for multiple UL communications or DL communications for the UE with different transmission characteristics and requirements.

36. The UE according to claim 33, wherein the dynamically splitting of resources is based on one or more rules.

37. The UE according to claim 36, wherein the one or more rules is based on a traffic buffer level at the network node or the UE.

38. The UE according to claim 36, wherein the one or more rules is defining that one or more DL transmissions are done first, and wherein using the resources comprises waiting of the one or more DL transmissions to end and then perform one or more UL transmissions on one or more remaining resources.

39. The UE according to claim 36, wherein the one or more rules is defining that one or more UL transmissions are done first and then one or more DL transmissions are performed on one or more remaining resources.

40. The UE according to claim 33, wherein the indication comprises a joint downlink control information, DCI, comprising parameters related to both DL decoding and UL encoding information.

41. The UE according to claim 33, wherein the UE is configured to use the resources by performing an UL transmission to the network node and transmitting a flag or control information indicating end of the UL transmission.

42. The UE according to claim 33, wherein the UE is configured to use the resources by receiving a flag or downlink control information, DCI, transmitted along physical downlink shared channel, PDSCH, defining the splitting of the resources, and then performing an UL transmission.
